(19) United States
(12) Patent Application Publication
(10) Pub. No.: US 2015/0312151 A1
(43) Pub. Date: Oct. 29, 2015

(54) ENHANCED LOAD DISTRIBUTION OF NON-UNICAST TRAFFIC TO MULTI-HOMED NODES IN A PORT EXTENDER ENVIRONMENT

(71) Applicant: DELL PRODUCTS L.P., Round Rock, TX (US)

(72) Inventor: Karthik Krishnamurthy, Palavanthangal Chennai (IN)

(73) Assignee: DELL PRODUCTS L.P., Round Rock, TX (US)

(21) Appl. No.: 14/264,531

(22) Filed: Apr. 29, 2014

(51) Int. Cl. H04L 12/743; H04L 12/715

(52) U.S. Cl. CPC H04L 45/7453; H04L 45/04

(57) ABSTRACT

Aspects of the present invention include multi-homed node in a port extender environment. In embodiments of the present invention, each port extender can communicate data traffic to the multi-homed node thereby increasing the number of available links to the multi-homed node. The communication with the multi-homed node is based on an identification associated with the data traffic.

### BACKGROUND

1. Field of Invention

The present invention relates generally to data communication networks and devices, and relates more particularly to port extender environments.

2. Description of the Related Art

As the value and use of information continues to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

As information handling systems provide increasingly more central and critical operations in modern society, it is important that the networks are reliable. One method used to improve reliability is to provide redundant links between network devices. By employing redundant links, network traffic between two network devices that would normally be interrupted can be re-routed to the back-up link in the event that the primary link fails.

In a network switch, there are a limited number of ports and each switch is managed individually. This complicates the management of switches within the network. One way to decrease the complexity in management of switches and increase the number of ports is to use port extenders. Port extension provides the capability to group different switches into a single logical switch, thus making it easier to manage different switches and also increases the number of ports which can be managed. In a port extender environment, a single controlling point is needed to manage the different switches and these managed switches are called the port extenders. In a port extender environment, there can be multi-homed nodes, meaning a node that is connected to more than one port extender.

In some prior art solutions, a controlling bridge is used as the controlling point in a multi-homed network. In prior art solutions, the port extenders blindly forward a packet of data to the controlling bridge via the uplink port.

FIG. 1 shows an example of a prior art solution. FIG. 1 shows controlling bridge 105, three port extenders 110, 115, and 120, three receivers 125, 130, and 135, and multi-homed node 140. In this example, there are three port extenders, PE1 120, PE2 115, and PE3 110. Each port extender can be a different switch. Each port in a port extender is known as an Extended Port and has a E-channel identifier (ECID). This would be used at the controlling bridge to identify the extended port present in the port extender in which the packet has come in. This E-channel identifier (ECID) is also used during transmission of a packet from the controlling bridge to an extended port present in the port extender. The E-channel identifier is encoded within a tag called the ETAG.

To identify on which port the packet comes in, the port extender adds a tag called ETAG in the packet and fills the channel identifier field in the ETAG. When a packet comes in on the downlink port, the port extender 110, 115, or 120 fills the channel identifier associated with the downlink port in the ETAG and forwards it to the controlling bridge 105. The controlling bridge 105 reads the E-Channel Identifier (ECID) from the ETAG and sees from which port the packet came.

There are virtual ports for each extended port present in the port extender 110, 115, and 120 at the controlling bridge 105. At the controlling bridge 105 there is a routing table look-up. If the destination is another port extender, the controlling bridge will have a table to look at the position and figure out the destination. The controlling bridge 105 will add an ETAG, fill the E-Channel Identifier (ECID) of the extended port and will forward the packet to the port extender 110, 115, and 120.

For example, if a unicast packet is traveling from port 148 in PE1 120 to port 152 in PE3 110, then PE1 120 will send the packet to the controlling bridge 105 on uplink 142 by filling the E-Channel identifier of the extender port 148. After the lookup in Media Access Control (MAC) Address table for the unicast packet the controlling bridge 105 will add or modify the ETAG by filling the E-Channel Identifier (ECID) of the final destination port 152 and send the packet to PE3 110 on downlink 144. At PE3 110, PE3 110 will look at the E-Channel Identifier (ECID) present in the ETAG and it will send it out to the receiver 135 on downlink 152.

In the above example, for a non-unicast case, a packet comes from PE1 120, PE1 120 will add an ETAG and an ingress E-Channel Identifier (ECID). PE1 120 will also send the packet to the controlling bridge 105. At the controlling bridge 105, there is no entry in the Media Access Control (MAC) Address table because it is not a unicast packet. Therefore, the controlling bridge will flood the packet out on the Virtual Local Area Networks (VLANs) to PE2 115 and PE3 110. Each VLAN will have a multi-cast ECID. A flooded packet will form a tree 142, 144, 146, 148, 150, 152, and 156.

In the example all the port extenders 110, 115, and 120 are connected to the same multi-homed node 140, so only one port extender sends the packet to the multi-homed node 140. In the example, PE1 120 sends the packet to the multi-homed node 140. If more than one port extender sent the packet, the multi-homed node would receive duplicate packets.

The problem is that only one port extender, PE1 120, sends packets to the multi-homed node 140. PE2 115 and PE3 110 never would send the packet to the multi-homed node 140.

One disadvantage of this system is that only one link is active per VLAN or per multicast group.

Accordingly, what is needed are systems and methods that can have more than one active link per VLAN.

### BRIEF DESCRIPTION OF THE DRAWINGS

Reference will be made to embodiments of the invention, examples of which may be illustrated in the accompanying figures, in which like parts may be referred to by like or similar numerals. These figures are intended to be illustrative, not limiting. Although the invention is generally described in the context of these embodiments, it should be understood that it is not intended to limit the spirit and scope of the invention to these particular embodiments. These drawings shall in no way limit any changes in form and detail that may be made to the invention by one skilled in the art without departing from the spirit and scope of the invention.

FIG. 1 depicts an example of a multi-homed node.

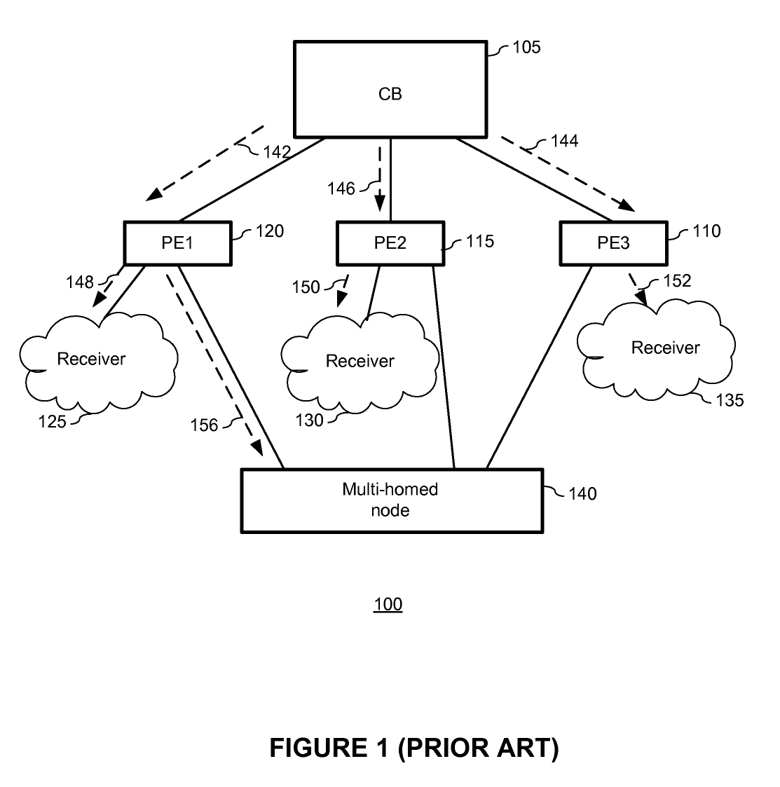

FIG. 2 depicts an example of a multi-homed node according to embodiments of the present invention.

FIG. 3 depicts an example of using a hash flow algorithm according to embodiments of the present invention.

FIG. 4 depicts a block diagram according to embodiments of the present invention.

FIG. 5 depicts a flowchart for data distribution according to embodiments of the present invention.

### DESCRIPTION OF THE PREFERRED EMBODIMENTS

In the following description, for purposes of explanation, specific examples and details are set forth in order to provide an understanding of the invention. It will be apparent, however, to one skilled in the art that the invention may be practiced without these details. Well known process steps may not be described in detail in order to avoid unnecessarily obscuring the present invention. Other applications are possible, such that the following examples should not be taken as limiting. Furthermore, one skilled in the art will recognize that aspects of the present invention, described herein, may be implemented in a variety of ways, including software, hardware, firmware, or combinations thereof.

Components, or modules, shown in block diagrams are illustrative of exemplary embodiments of the invention and are meant to avoid obscuring the invention. It shall also be understood that throughout this discussion that components may be described as separate functional units, which may comprise sub-units, but those skilled in the art will recognize that various components, or portions thereof, may be divided into separate components or may be integrated together, including integrated within a single system or component. It should be noted that functions or operations discussed herein may be implemented as components or modules.

Furthermore, connections between components within the figures are not intended to be limited to direct connections. Rather, data between these components may be modified, re-formatted, or otherwise changed by intermediary components (which may or may not be shown in the figure). Also, additional or fewer connections may be used. It shall also be noted that the terms “coupled” or “communicatively coupled” shall be understood to include direct connections, indirect connections through one or more intermediary devices, and wireless connections.

In the detailed description provided herein, references are made to the accompanying figures, which form a part of the description and in which are shown, by way of illustration, specific embodiments of the present invention. Although these embodiments are described in sufficient detail to enable one skilled in the art to practice the invention, it shall be understood that these examples are not limiting, such that other embodiments may be used, and changes may be made without departing from the spirit and scope of the invention.

Reference in the specification to “one embodiment,” “preferred embodiment,” “an embodiment,” or “embodiments” means that a particular feature, structure, characteristic, or function described in connection with the embodiment is included in at least one embodiment of the invention and may be in more than one embodiment. Also, such phrases in various places in the specification are not necessarily all referring to the same embodiment or embodiments. It shall be noted that the use of the terms “set” and “group” in this patent document shall include any number of elements. Furthermore, it shall be noted that methods or algorithms steps may not be limited to the specific order set forth herein; rather, one skilled in the art shall recognize, in some embodiments, that more or fewer steps may be performed, that certain steps may optionally be performed, and that steps may be performed in different orders, including being done some steps being done concurrently.

The present invention relates in various embodiments to devices, systems, methods, and instructions stored on one or more non-transitory computer-readable media involving the communication of data over networks. Such devices, systems, methods, and instructions stored on one or more non-transitory computer-readable media can result in, among other advantages, better bandwidth usage, better scalability, and better reliability by mitigating the effects of down links and other points of failure across data networks. The terms “packet” or “frame” shall be understood to mean a group of bits that can be transported across a network. The term “frame” shall not be interpreted as limiting embodiments of the present invention to Layer 2 networks; and, the term “packet” shall not be interpreted as limiting embodiments of the present invention to Layer 3 networks. The terms “packet,” “frame,” “data,” or “data traffic” may be replaced by other terminologies referring to a group of bits, such as “datagram” or “cell.” One skilled in the art shall recognize that references herein to Media Access Control (MAC) address may, depending upon context, refer to MAC-VLAN combination.

It shall also be noted that although embodiments described herein may be within the context of non-unicast transmission and multi-homed nodes, the invention elements of the current patent document are not so limited. Accordingly, the invention elements may be applied or adapted for use in other contexts.

As described above, in prior art solutions, when a node is multi-homed to different port extenders, non-unicast data traffic from a controlling bridge is allowed to flow from only one of the designated port extenders to avoid reception of duplicate packets. Typically the designated port extender is chosen on a per VLAN or on a per group basis. Although this system provides distribution of non-unicast data over the multi-homed links, only one link is active for a VLAN or for a multicast group. In embodiments of the present invention the restriction of having only one link active per VLAN or per multicast group when a node is multi-homed to different port extenders is removed. Thus advantages can be achieved, such as redundancy, better bandwidth utilization, and faster recovery in the event one of the multi-homed links goes down.

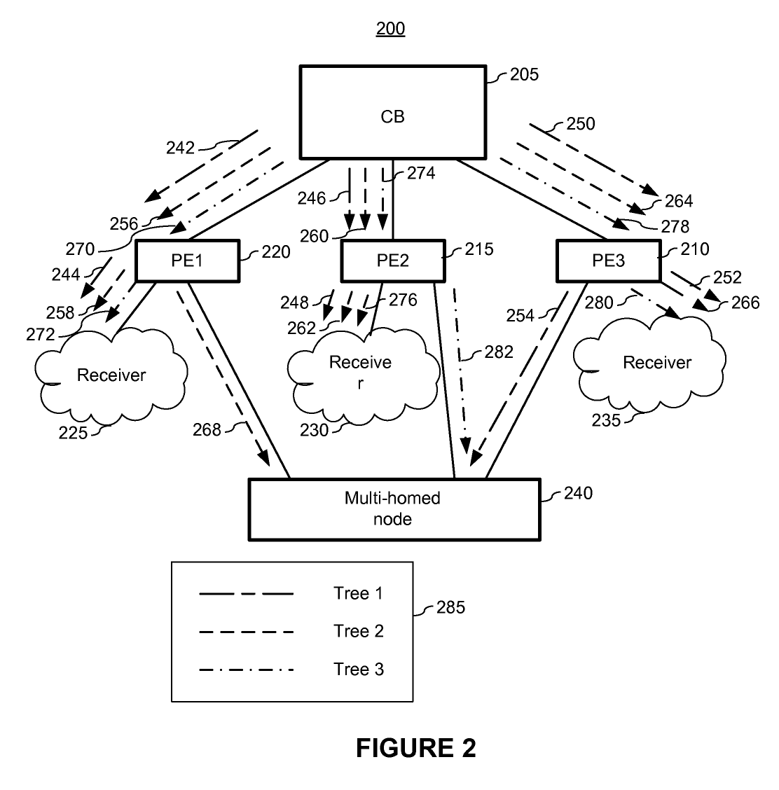

FIG. 2 depicts an example of a multi-homed node according to embodiments of the present invention. FIG. 2 shows a multi-homed node with three trees. The example in FIG. 2 illustrates the case of three port extenders connected to the same multi-homed node. However, one of ordinary skill in the art will appreciate that three port extenders is chosen for ease of explanation and is not intended to limit the number of port extenders to any particular number.

FIG. 2 shows controlling bridge 205, port extenders 210, 215, and 220, receivers 225, 230, and 235, and multi-homed node 240. FIG. 2 also shows three trees as shown in box 285. The first tree is shown by communications links 242, 244, 246, 248, 250, 252, and 254. The second tree is shown by communications links 256, 258, 260, 262, 264, 266, and 268. The third tree is shown by communications links 270, 272, 274, 276, 278, 280, and 282.

An example of communication flow in accordance with the embodiment shown in FIG. 2 is that when a packet comes in to the controlling bridge 205 from a particular port extender 210, 215, or 220, it would be flooded to other port extenders 210, 215, and 220 and therefore to receivers 225, 230, and 235. Also, one port extender 210, 215, or 220 can forward the packet to the multi-homed node 240. However, only one port extender 210, 215, or 220 will forward the packet to the multi-homed node 240. The determination of which port extender 210, 215, or 220 is based on the E-Channel Identifier (ECID).

The controlling bridge selects a multicast ECID. The port extender to forward to the multi-homed node 240 is based on the ECID used. Since all the port extenders can forward to the multi-homed node, more than one link is used to connect to the multi-homed node 240.

In some embodiments of the present invention, when a multi-homed node 240 is in the multicast replication path, the controlling bridge 205 can create a multicast replication tree bundle 285. The multicast replication tree bundle could contain multicast replication trees where each tree would have one of the links in to the port extender 210, 215, or 220 connecting to a multi-homed node 240 as a branch.

In embodiments of the present invention, each of trees within the tree bundle could be identified by a multicast ECID. The port extenders connected to the multi-homed node could be configured in such a way that only one of them could forward to the multi-homed node for each multicast ECID within the tree bundle.

In embodiments of the present invention, hardware flow based hashing mechanism could be used to choose one of the trees within the tree bundle. So for different non-unicast flows on the same VLAN, different trees could be chosen and hence traffic would flow on different multi-homed links, achieving better distribution.

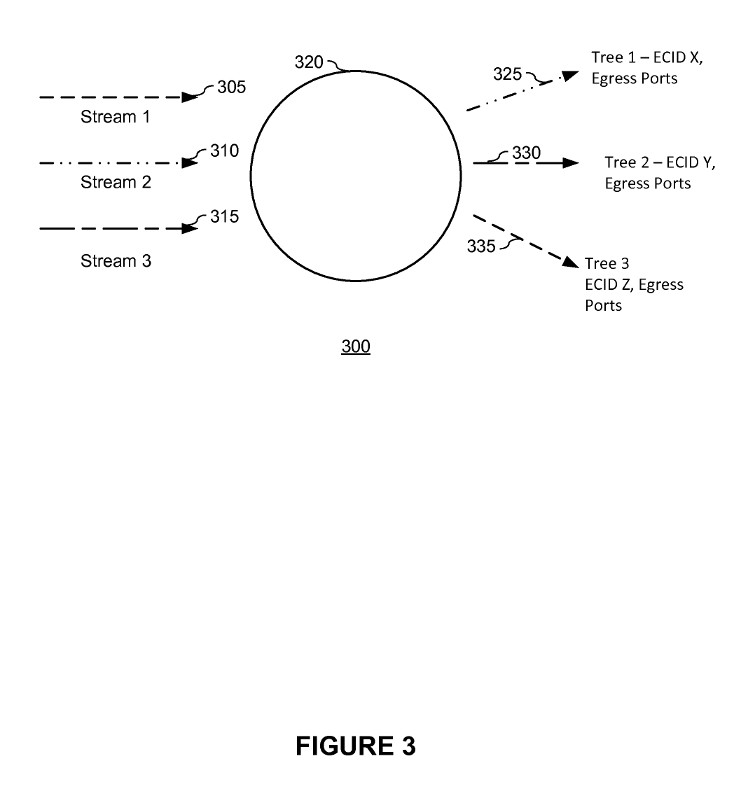

FIG. 3 depicts an example of using a hash flow algorithm according to embodiments of the present invention. FIG. 3 shows stream 1 305, stream 2 310, and stream 3 315 as inputs to hash flow algorithm 320. FIG. 3 also shows tree 1, ECID X, egress points 325, tree 2 ECID Y, egress points 330, and tree 3 ECID Z, egress points 335. FIG. 3 shows using a flow hash modulo n 320, where n is the number of trees in the tree bundle.

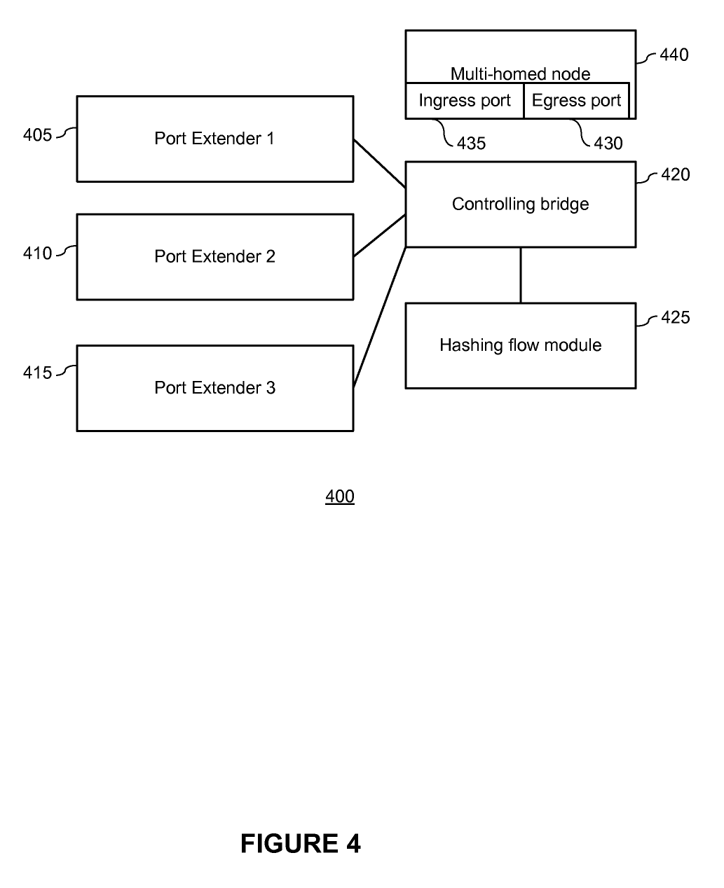

FIG. 4 depicts a block diagram according to embodiments of the present invention. FIG. 4 shows port extender environment 400 including three port extenders 405, 410, and 415, controlling bridge 420, hashing flow module 425, and multi-homed node 440. Multi-homed node 240 includes ingress port 435 and egress port 430.

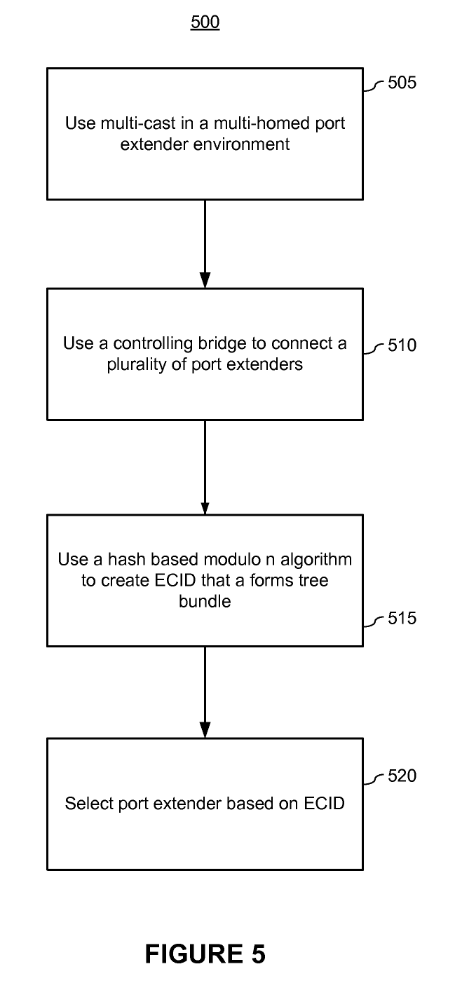

FIG. 5 depicts a flowchart for data distribution according to embodiments of the present invention. FIG. 5 shows flow 500 including use multi-cast in a multi-homed port extender environment 505, use a controlling bridge to connect a plurality of port extenders 510, use a hash based modulo n algorithm to create ECID that a forms tree bundle 515, and select port extender based on ECID 520. Using this method allows for multiple links to the multi-homed node.

Embodiments of the present invention have many advantages. For example, they allow better bandwidth utilization of the multi homed links. Other advantages include faster recovery in case when one of the multi-homed links goes down. For example, if one the multi-homed links connecting to the port extender goes down, the controlling bridge would just need to remove the tree which has this link from the tree bundle. Once that tree is removed from the tree bundle, traffic could start flowing immediately through alternate multi-homed link as the hash compute is modulo N. The controlling bridge need not reprogram the paths at the port extenders if the multi-homed links go down.

It shall be noted that aspects of the present invention may be encoded upon one or more non-transitory computer-readable media with instructions for one or more processors or processing units to cause steps to be performed. It shall be noted that the one or more non-transitory computer-readable media shall include volatile and non-volatile memory. It shall be noted that alternative implementations are possible, including a hardware implementation or a software/hardware implementation. Hardware-implemented functions may be realized using ASIC(s), programmable arrays, digital signal processing circuitry, or the like. Accordingly, the “means” terms in any claims are intended to cover both software and hardware implementations. Similarly, the term “computer-readable medium or media” as used herein includes software and/or hardware having a program of instructions embodied thereon, or a combination thereof. With these implementation alternatives in mind, it is to be understood that the figures and accompanying description provide the functional information one skilled in the art would require to write program code (i.e., software) and/or to fabricate circuits (i.e., hardware) to perform the processing required.

While the inventions have been described in conjunction with several specific embodiments, it is evident to those skilled in the art that many further alternatives, modifications, application, and variations will be apparent in light of the foregoing description. Thus, the inventions described herein are intended to embrace all such alternatives, modifications, applications and variations as may fall within the spirit and scope of the appended claims.

What is claimed is:

1. A multi-homed node information handling system in a port extender environment, comprising:
a multi-homed node, configurable to connect to at least one port extender environment;
a plurality of port extenders, coupled to the multi-homed node, each configurable to forward data traffic to the multi-homed node;
a controlling bridge, coupled to the plurality of port extenders, that processes data traffic and receives data from and sends data to at least one of the plurality of port extenders; and
at least one hash flow module that uses a hashing system to assign an identification to the data traffic.

2. The multi-homed node information handling system of claim 1 wherein the identification is an E-Channel Identifier (ECID).

3. The multi-homed node information handling system of claim 2 wherein the ECID determines which of the plurality of port extenders forwards the data traffic.

4. The multi-homed node information handling system of claim 1 wherein each of the plurality of port extenders is configurable to forward data traffic.

5. The multi-homed node information handling system of claim 1 wherein the hash flow module uses a hashing algorithm to assign the identification.

6. The multi-homed node information handling system of claim 1 wherein the information handling system is a non-unicast system.

7. A method for distribution of non-unicast data traffic to a multi-homed node in a port extender environment, comprising:
using a controlling bridge to connect a plurality of port extenders and to forward data traffic to at least one of the plurality of port extenders;
assigning an identification to the data traffic using a hash flow algorithm and
selecting the port extender to be used to forward the data traffic based on the identification assigned.

8. The method of claim 7 wherein the data traffic flow forms a plurality of trees.

9. The method of claim 8 wherein the hash flow algorithm uses hash flow modulo n, where n is the number of trees.

10. The method of claim 7 wherein the identification assigned is an E-Channel Identifier (ECID).

11. The method of claim 7 wherein each of the plurality of port extenders can be used to forward data traffic.

12. The method of claim 7 further comprising forwarding data traffic from at least one of the plurality of port extenders to a multi-homed node.

13. The method of claim 12 wherein the multi-homed node is configurable to receive data traffic from each of the plurality of port extenders.

14. A multi-homed node comprising:
an ingress port configurable to receive data traffic forwarded by one of a plurality of port extenders, the port extender selected based on an identification associated with the data traffic; and
an egress port configurable to forward data traffic to one of a plurality of port extenders.

15. The multi-homed node of claim 14 wherein the identification is an E-Channel Identifier (ECID).

16. The multi-homed node of claim 15 wherein the ECID determines which of the plurality of port extenders forwards the data traffic.

17. The multi-homed node of claim 14 wherein the identification is assigned using a hash flow algorithm.

18. The multi-homed node of claim 17 wherein the hash flow algorithm us modulo n, where n is the number of port extenders.

19. The multi-homed node of claim 14 wherein the ingress port receives non-unicast data traffic from the plurality of port extenders.

20. The multi-homed node of claim 14 wherein the ingress port receives data traffic from each of the plurality of port extenders.
